(19) United States
(12) Patent Application Publication
(10) Pub. No.: US 2003/0130388 A1
(43) Pub. Date: Jul. 10, 2003

(54) Blocked mercaptosilanes

(75) Inventors: Hans-Detlef Luginsland, Koeln (DE); Roland Krafczyk, Rheinfelden (DE); Frank Forster, Schoellkrippen (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: Degussa AG, Duesseldorf (DE)

(21) Appl. No.: 10/254,658

(22) Filed: Sep. 26, 2002

(30) Foreign Application Priority Data
Sep. 26, 2001 (DE) 101 47 520.9
Dec. 22, 2001 (DE) 101 63 945.7

(51) Int. Cl. C07F 7/04; C08K 5/24

(52) U.S. Cl. 524/261; 556/427

(57) ABSTRACT

Blocked mercaptosilanes, having the following general formula I

(R¹O)₃Si—R²—S—C(═O)—C₁₇H₃₅ (I).

which are produced by reacting the corresponding mercaptosilane (R¹O)₃Si—R²—SH with stearoyl chloride in the presence of an auxiliary base in a suitable organic solvent, the mixture is heated to boiling point to complete the reaction, it is filtered off from the solid residue that forms and the solvent is distilled off; the blocked mercaptosilanes can be used in rubber compounds.

### BACKGROUND OF THE INVENTION

1. Field of the Invention

The invention relates to blocked mercaptosilanes, a process for the production thereof and their use.

2. Description of the Background

From WO 99/09036, blocked mercaptosilanes of the formula [[(ROC(═O))ₚ—(G)ⱼ]ₖ—Y—S]ᵣ—G—(SiX₃)ₛ and [(X₃Si)_{q}—G]ₐ—[Y—[S—G—SiX₃]_{b}]_{c} are known.

Furthermore, from U.S. Pat. No. 6,127,468, a process for the production of filled rubber is known, wherein rubber, a blocked mercaptosilane and an inorganic filler are mixed, a deblocking agent of the formula R₂NC(═S)—Sₙ—C(═S)NR₂ is added to the mixture and the mixture is vulcanised.

Disadvantages of the known blocked mercaptosilanes are their low reinforcing action and poor processability.

### SUMMARY OF THE INVENTION

The object of the present invention is to develop a blocked mercaptosilane that can be produced cheaply and has a high modulus and reinforcing factor as well as good processability and dynamic properties.

The invention provides blocked mercaptosilanes, having the following general formula I

(R¹O)₃Si—R²—S—C(═O)—C₁₇H₃₅ (I)

wherein R¹, independently of one another, represents H or (C₁-C₈) alkyl, R² represents a linear or branched, saturated or unsaturated (C₁-C₈) divalent hydrocarbon, and the alkyl group C₁₇H₃₅ is branched or linear.

### DETAILED DESCRIPTION OF THE INVENTION

The invention provides blocked mercaptosilanes, having the following general formula I

(R¹O)₃Si—R²—S—C(═O)—C₁₇H₃₅ (I)

wherein

R¹, independently of one another, represents H or (C₁-C₈) alkyl, preferably methyl or ethyl,

R² represents a linear or branched, saturated or unsaturated (C₁-C₈) divalent hydrocarbon, preferably CH₂, CH₂CH₂, CH₂CH₂CH₂, CH₂CH₂CH₂CH₂, CH(CH₃), CH₂CH(CH₃), C(CH₃)₂, CH(C₂H₅), CH₂CH₂CH(CH₃), CH₂CH(CH₃)CH₂ or

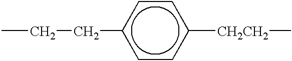

, and

the alkyl group C₁₇H₃₅ is branched or linear.

In a particular embodiment of the invention, R¹ is ethyl, R² is CH₂CH₂CH₂, and the alkyl group C₁₇H₃₅ is linear ((CH₂)₁₆CH₃).

Examples of the blocked mercaptosilanes of formula (I) according to the invention are:

(CH₃O)₃Si—CH₂—S—C(═O)—C₁₇H₃₅, (CH₃O)₃Si—CH₂CH₂—S—C(═O)—C₁₇H₃₅, (CH₃O)₃Si—CH₂CH₂CH₂—S—C(═O)—C₁₇H₃₅, (CH₃O)₃Si—CH₂CH₂CH₂CH₂—S—C(═O)—C₁₇H₃₅, (CH₃O)₃Si—CH₂CH₂CH₂CH₂CH₂—S—C(═O)—C₁₇H₃₅, (C₂H₅O)₃Si—CH₂—S—C(═O)—C₁₇H₃₅, (C₂H₅O)₃Si—CH₂CH₂—S—C(═O)—C₁₇H₃₅, (C₂H₅O)₃Si—CH₂CH₂CH₂—S—C(═O)—C₁₇H₃₅, (C₂H₅O)₃Si—CH₂CH₂CH₂CH₂—S—C(═O)—C₁₇H₃₅ or (C₂H₅O)₃Si—CH₂CH₂CH₂CH₂CH₂—S—C(═O)—C₁₇H₃₅.

The invention also provides a process for the production of the blocked mercaptosilanes of the general formula I, which is characterised in that the corresponding mercaptosilane of the formula (R¹O)₃Si—R²—SH is reacted with stearoyl chloride in the presence of an auxiliary base in a suitable organic solvent, the mixture is heated to boiling point to complete the reaction, it is filtered off from the solid residue that forms and the solvent is distilled off.

Examples of the mercaptosilanes of the formula (R¹O)₃Si—R²—SH are: (CH₃O)₃Si—CH₂—SH, (CH₃O)₃Si—CH₂CH₂—SH, (CH₃O)₃Si—CH₂CH₂CH₂—SH, (CH₃O)₃Si—CH₂CH₂CH₂CH₂—SH, (CH₃O)₃Si—CH₂CH₂CH₂CH₂CH₂—SH, (C₂H₅O)₃Si—CH₂—SH, (C₂H₅O)₃Si—CH₂CH₂—SH, (C₂H₅O)₃Si—CH₂CH₂CH₂—SH, (C₂H₅O)₃Si—CH₂CH₂CH₂CH₂—SH or (C₂H₅O)₃Si—CH₂CH₂CH₂CH₂CH₂—SH.

Triethylamine or other amines can be used as the auxiliary base.

Alkanes can be used as the organic solvent.

The blocked mercaptosilanes according to the invention are particularly suitable for use in rubber compounds.

The invention also provides rubber compounds containing rubber, filler, preferably precipitated silica, and optionally other rubber auxiliaries, as well as at least one blocked mercaptosilane of formula I according to the invention in a quantity of 0.11 to 15 wt. %, preferably 5-10 wt. %, based on the quantity of the oxidic or other filler used, and optionally a deblocking agent.

The addition of the blocked mercaptosilanes according to the invention and the addition of the fillers can preferably take place at stock temperatures of 100 to 200° C., but it can also take place later at lower temperatures (40 to 100° C.), for example together with other rubber auxiliaries.

The blocked mercaptosilane according to the invention can be added to the mixing process both in pure form and applied on to an inert organic or inorganic support. Preferred support materials can be silicas, natural or synthetic silicates, waxes, thermoplastics, aluminium oxide or carbon blacks.

The following can be used as fillers for the rubber compounds according to the invention:

Carbon blacks: the carbon blacks to be used here are produced by the lampblack, furnace or gas black process and possess BET surface areas of 20 to 200 m²/g. The carbon blacks can optionally also contain heteroatoms, such as e.g. Si.

Highly disperse silicas, produced e.g. by precipitation from solutions of silicates or flame pyrolysis of silicon halides with specific surfaces of 5 to 1000, preferably 20 to 400 m²/g (BET surface area) and with primary particle sizes of 10 to 400 nm. The silicas can optionally also be present as mixed oxides with other metal oxides, such as Al, Mg, Ca, Ba, Zn and Ti oxides.

Synthetic silicates, such as aluminium silicate, alkaline earth silicates such as magnesium silicate or calcium silicate, with BET surface areas of 20 to 400 m²/g and primary particle diameters of 10 to 400 nm.

Synthetic or natural aluminium oxides and hydroxides.

Natural silicates, such as kaolin and other naturally occurring silicas.

Glass fibres and glass fibre products (mats, strands) or microglass beads.

Carbon blacks with BET surface areas of 20 to 400 m²/g or highly disperse silicas, produced by precipitation from solutions of silicates, with BET surface areas of 20 to 400 m²/g, can preferably be used in quantities of 5 to 150 parts by weight, based in each case on 100 parts of rubber.

The fillers mentioned can be used individually or in a mixture. In a particularly preferred embodiment of the process, 10 to 150 parts by weight of light-coloured fillers can be used, optionally together with 0 to 100 parts by weight of carbon black, and also 0.1 to 15 parts by weight, preferably 5 to 10 parts by weight, of a compound of formula (I), based in each case on 100 parts by weight of the filler used, to produce the mixtures.

For the production of rubber compounds according to the invention, apart from natural rubber, synthetic rubbers are also suitable. Preferred synthetic rubbers are described e.g. in W. Hofmann, Kautschuktechnologie, Genter Verlag, Stuttgart 1980. They include, among others,

Polybutadiene (BR),

Polyisoprene (IR),

Styrene/butadiene copolymers with styrene contents of 1 to 60, preferably 2 to 50 wt. % (SBR),

Isobutylene/isoprene copolymers (IIR),

Butadiene/acrylonitrile copolymers with acrylonitrile contents of 5 to 60, preferably 10 to 50 wt. % (NBR),

Partially hydrogenated or fully hydrogenated NBR rubber (HNBR),

Ethylene/propylene/diene copolymers (EPDM),

and mixtures of these rubbers. For the production of vehicle tires, anionically polymerised S-SBR rubbers (solution SBR) with a glass transition temperature of more than −50° C. and mixtures thereof with diene rubbers are of particular interest.

As a deblocking agent, tertiary amines, Lewis acids, thiols or nucleophiles, e.g. primary, secondary or C═N-containing amine, can be used. Examples of deblocking agents are R₂NC(═S)—Sₙ—C(═S)NR₂, wherein n=1-4 and R is a C₁-C₄ alkyl group, N,N′-diphenylguanidine, N,N′,N″-triphenylguanidine, N,N′-di-ortho-tolylguanidine, ortho-biguanidine, hexamethylenetetramine, cyclohexylethylamine, dibutylamine, thiuram and 4,4′-diaminodiphenylmethane.

The rubber compounds according to the invention can contain other rubber auxiliary products, such as reaction accelerators, antioxidants, heat stabilisers, light stabilisers, anti-ozonants, processing aids, plasticisers, tackifiers, blowing agents, dyes, waxes, extenders, organic acids, inhibitors, metal oxides and activators, such as triethanolamine, polyethylene glycol and hexanetriol, which are known to the rubber industry.

The rubber auxiliaries can be used in conventional quantities, which depend on the intended application, among other things. Conventional quantities are e.g. quantities of 0.1 to 50 wt. %, based on rubber. The blocked mercaptosilane can be used on its own as a crosslinking agent. The addition of other crosslinking agents is generally recommended. Sulfur or peroxides can be used as other known crosslinking agents. The rubber compounds according to the invention can, in addition, contain vulcanisation accelerators. Examples of suitable vulcanisation accelerators are mercaptobenzothiazoles, sulfonamides, guanidines, thiurams, dithiocarbamates, thioureas and thiocarbonates. The vulcanisation accelerators and sulfur or peroxides are used in quantities of 0.1 to 10 wt. %, preferably 0.1 to 5 wt. %, based on rubber.

The vulcanisation of the rubber compounds according to the invention can take place at temperatures of 100 to 200° C., preferably 130 to 180° C., optionally under pressure of 10 to 200 bar.

The rubber or the mixture of rubbers, the filler, optionally rubber auxiliaries, the blocked mercaptosilane according to the invention and optionally the deblocking agent can be mixed in mixing units such as rollers, internal mixers and mix extruders. The rubber vulcanisation products according to the invention are suitable for the production of mouldings, e.g. for the production of pneumatic tires, tire treads, cable sheaths, hoses, transmission belts, conveyor belts, roller coatings, tires, shoe soles, packing rings and damping elements.

When the blocked mercaptosilanes according to the invention are used in rubber compounds, advantages are displayed compared with the compounds according to the prior art in the increased reinforcing action, lower mix viscosity and better processability.

### EXAMPLES 1-4

### Production of the Blocked Mercaptosilanes

### Example 1 (Comparative Example)

Preparation of (EtO)₃Si—(CH₂)₃—S—C(═O)—C₈H₁₇

87.73 g of pelargonoyl chloride are added dropwise to a solution of 118.39 g of 3-mercaptopropyltriethoxysilane in 820 ml of petroleum ether (boiling range 50-70° C.) at 5° C. after adding 57.78 g of triethylamine. After heating with reflux for 90 min, the cooled suspension is filtered, the filter cake rewashed twice with petroleum ether and the filtrates obtained are combined and the solvent removed. 187.74 g of liquid product are obtained, the identity of which is confirmed by ¹H-NMR spectroscopy.

Example 2 (Comparative Example)

Preparation of (EtO)₃Si—(CH₂)₃—S—C(═O)—C₁₅H₃₁

113.75 g of palmitoyl chloride are added dropwise to a solution of 98.66 g of 3-mercaptopropyltriethoxysilane in 1300 ml of petroleum ether (boiling range 50-70° C.) at 8° C. after adding 48.15 g of triethylamine. After heating with reflux for 60 min, the cooled suspension is filtered, the filter cake rewashed twice with petroleum ether and the filtrates obtained are combined and the solvent removed. 183.30 g of liquid product are obtained, the identity of which is confirmed by ¹H-NMR spectroscopy.

### Example 3

Preparation of (EtO)₃Si—(CH₂)₃—S—C(═O)—C₁₇H₃₅

125.35 g of stearoyl chloride are added dropwise, using a heatable dropping funnel, to a solution of 98.66 g of 3-mercaptopropyltriethoxysilane in 1300 ml of petroleum ether (boiling range 50-70° C.) at 5° C. after adding 48.15 g of triethylamine. After heating with reflux for 90 min, the cooled suspension is filtered, the filter cake rewashed twice with petroleum ether and the filtrates obtained are combined and the solvent removed. 186.71 g of liquid product are obtained, the identity of which is confirmed by ¹H-NMR spectroscopy.

### Example 4 (Comparative Example)

Preparation of (EtO)₃Si—(CH₂)₃—S—C(═O)—C₂₁H₄₃

148.57 g of behenoyl chloride are added to a solution of 98.66 g of 3-mercaptopropyltriethoxysilane in 1300 ml of petroleum ether (boiling range 50-70° C.) at 5° C. using a solids metering device, after adding 48.15 g of triethylamine. After heating with reflux for 90 min, the cooled suspension is filtered, the filter cake rewashed twice with petroleum ether and the filtrates obtained are combined and the solvent removed. 213.55 g of low-melting product are obtained, the identity of which is confirmed by ¹H-NMR spectroscopy.

### EXAMPLES 5-9

### Rubber Testing

The general formulation used for the rubber compounds is given in Table 1 below. The unit phr here means parts by weight, based on 100 parts of the crude rubber used. The silanes are metered in equimolar quantities in Examples 5-9.

TABLE 1

| | Example | Example | Example | Example | Example |
|---|---|---|---|---|---|
| Substance | 5 | 6 | 7 | 8 | 9 |
| 1^{st} stage | [phr] | [phr] | [phr] | [phr] | [phr] |
| Buna VSL | 75.0 | 75.0 | 75.0 | 75.0 | 75.0 |
| 4515-0 | | | | | |
| Buna CB 24 | 25.0 | 25.0 | 25.0 | 25.0 | 25.0 |
| Ultrasil | 80.0 | 80.0 | 80.0 | 80.0 | 80.0 |
| 7000 GR | | | | | |
| Si 69 | 7.0 | — | — | — | — |
| Silane | — | 9.95 | — | — | — |
| Example 1 | | | | | |
| Silane | — | — | 12.53 | — | — |
| Example 2 | | | | | |
| Silane | — | — | — | 13.26 | — |
| Example 3 | | | | | |
| Silane | — | — | — | — | 14.74 |
| Example 4 | | | | | |
| ZnO | 2.5 | 2.5 | 2.5 | 2.5 | 2.5 |
| Stearic acid | 1.0 | 1.0 | 1.0 | 1.0 | 1.0 |
| Naftolen ZD | 32.5 | 32.5 | 32.5 | 32.5 | 32.5 |
| Vulkanox | 2.0 | 2.0 | 2.0 | 2.0 | 2.0 |
| 4020 | | | | | |
| Protector | 1.5 | 1.5 | 1.5 | 1.5 | 1.5 |
| G35P | | | | | |
| 3^{rd} stage | | | | | |
| Stage 2 | | | | | |
| batch | | | | | |
| DPG | 2.0 | 2.0 | 2.0 | 2.0 | 2.0 |
| CBS | 1.7 | 1.7 | 1.7 | 1.7 | 1.7 |
| Sulfur | 2.2 | 2.2 | 2.2 | 2.2 | 2.2 |

The polymer Buna VSL 4515-0 is a solution-polymerised SBR copolymer from Bayer AG with a styrene content of 15 wt. % and a butadiene content of 85 wt. %. 45% of the monomer units of the butadiene are 1,2 linked.

The polymer Buna CB 24 is a cis-1,4-polybutadiene from Bayer AG with a cis-1,4 content of at least 96% and a Mooney viscosity of between 44 and 50.

Ultrasil 7000 GR is a silica from Degussa AG with a BET surface area of 170 m²/g.

Si 69 is bis(3-triethoxysilylpropyl)tetrasulfane from Degussa AG.

Naftolen ZD from Chemetall is used as an aromatic oil. Vulkanox 4020 is PPD from Bayer AG. Protektor G35P is an anti-ozonant wax from HB-Fuller GmbH. Vulkacit D (DPG) and Vulkacit CZ (CBS) are commercial products from Bayer AG.

The rubber compound is prepared in three stages in an internal mixer in accordance with the data given in Table 2:

TABLE 2
Stage 1

| | |
|---|---|
| Settings | |
| Mixing unit | Werner & Pfleiderer GK 1.5E |
| Friction | 1:1 |
| Speed | 70 min⁻¹ |
| Ram pressure | 5.5 bar |
| Empty volume | 1.58 1 |
| Filling level | 0.55 |
| Flow temperature | 70° C. |
| Mixing operation | |
| 0 to 1 min | Polymer |
| 1 to 3 min | 1/2 silica, carbon black, ZnO, stearic acid, silane, oil |
| | 1/2 silica, antioxidant |
| 3 to 4 min | clean |
| 4 min | mix |
| 4 to 5 min | clean |
| 5 min | mix and deliver |
| 5 to 6 min | |
| Storage | 24 h at room temperature |

Stage 2

| | |
|---|---|
| Settings | |
| Mixing unit | as in stage 1 except |
| Speed | variable |
| Filling level | 0.51 |
| Flow temperature | 80° C. |
| Mixing operation | |
| 0 to 2 min | Stage 1 batch |
| 2 to 5 min | mix at 145° to 155° C. |
| 5 min | deliver |
| | and form milled sheet on laboratory roll mill |
| | (diameter 200 mm, length 450 mm, flow |
| | temperature 50° C.) then, sheet out |
| Batch temperature | 100-110° C. |

Stage 3

| | |
|---|---|
| Settings | |
| Mixing unit | as in stage 2 except |
| Speed | 40 min⁻¹ |
| Filling level | 0.49 |
| Flow temperature | 50° C. |
| Mixing operation | |
| 0 to 2 min | Stage 2 batch, sulfur, accelerator |
| 2 min | deliver |
| | and homogenise in laboratory roll mill (diameter |
| | 200 mm, length 450 mm, flow temperature 50° C.) |
| | cut in 3* left, 3* right |
| | then, sheet out |

The vulcanisation period for the test pieces is 20 minutes at 165° C.

The rubber testing takes place by the test methods given in Table 3.

TABLE 3

| Physical testing | Standard/conditions |
|---|---|
| ML 1 + 4, 100° C. | DIN 53523/3, ISO 667 |
| Vulcameter test, 165° C. | DIN 53529/3, ISO 6502 |
| Tensile test on ring, 23° C. | DIN 53504, ISO 37 |
| Tensile strength | |
| Moduli | |
| Elongation at break | |
| Shore A hardness, 23° C. | DIN 53 505 |
| Ball rebound, 0 and 60° C. | ASTM D 5308 |
| Viscoelastic properties, | DIN 53 513, ISO 2856 |
| 0 and 60° C., 16 Hz, 50 N preliminary | |
| force and 25 N amplitude force | |
| Complex modulus E*, | |
| Loss factor tan δ | |
| Goodrich flexometer, 25 min at | DIN 53 533, ASTM D 623 A |
| 23° C. and 0.175 inch stroke | |
| DIN abrasion, 10 N force | DIN 53 516 |
| Compression set, 22 h | DIN 53 517, ISO 815 |
| at 70° C. | |
| Dispersion | ISO/DIS 11345 |

The following technical data for crude mixture and vulcanisation product are determined (Table 4):

TABLE 4

| | Unit | Example 5 | Example 6 | Example 7 | Example 8 | Example 9 |
|---|---|---|---|---|---|---|
| Crude mixture results | | | | | | |
| Feature: | | | | | | |
| Hitec 165° C. | | | | | | |
| Dmax-Dmin | [dNm] | 6.6 | 6.9 | 6.2 | 5.9 | 5.5 |
| t 10% | [min] | 5.5 | 5.3 | 5.4 | 5.2 | 6.4 |
| t 90% | [min] | 10.8 | 8.3 | 8.3 | 8.9 | 10.0 |
| ML 1 + 4 100° C. 3^{rd} stage | [ME] | 53 | 35 | 32 | 33 | 32 |
| Vulcanisation product results | | | | | | |
| Feature: | | | | | | |
| Tensile test on ring | | | | | | |
| Tensile strength | [MPa] | 14.7 | 13.8 | 13.6 | 13.9 | 13.7 |
| Modulus 100% | [MPa] | 1.9 | 1.9 | 1.7 | 1.7 | 1.5 |
| Modulus 300% | [MPa] | 10.1 | 9.5 | 7.7 | 8.1 | 6.6 |
| Elongation at break | [%] | 380 | 390 | 440 | 430 | 500 |
| Modulus 300%/100% | [−] | 5.3 | 5.0 | 4.5 | 4.8 | 4.4 |
| Shore A hardness (23° C.) | [SH] | 64 | 60 | 58 | 58 | 57 |
| Ball rebound 60° C. | [%] | 60.1 | 58.9 | 61.1 | 60.3 | 60.4 |
| DIN abrasion | [mm³] | 62 | 76 | 93 | 89 | 103 |
| Goodrich flexometer. | | | | | | |
| 0.175 inch, 25 min., 23° C. | | | | | | |
| Contact temperature | [° C.] | 48 | 44 | 43 | 44 | 44 |
| Puncture temperature | [° C.] | 95 | 84 | 82 | 85 | 84 |
| Permanent set | [%] | 2.9 | 2.0 | 1.4 | 1.5 | 1.4 |
| MTS, 16 Hz, 50 N +/− 25 N | | | | | | |
| E*, 0° C. | [MPa] | 15.1 | 12.4 | 12.6 | 10.3 | 15.7 |
| E*, 60° C. | [MPa] | 7.5 | 7.7 | 7.2 | 6.7 | 6.9 |
| Loss factor tanδ, 0° C. | [−] | 0.329 | 0.278 | 0.278 | 0.270 | 0.320 |
| Loss factor tanδ, 60° C. | [−] | 0.148 | 0.123 | 0.127 | 0.129 | 0.134 |
| Phillips dispersion | [−] | 8 | 8 | 8 | 9 | 7 |

As shown by Table 4, the silane according to the invention in Example 8 gives the lowest E*(0° C.) value when metered in equimolar quantities, which indicates improved winter properties in tire treads. Moreover, Example 8 has the best dispersion value and is distinguished by a high modulus compared with Examples 7 and 9.

### EXAMPLES 10-14

### Rubber Testing

The general formulation used for the rubber compounds is given in Table 5 below. The unit phr here means parts by weight, based on 100 parts of the crude rubber used.

TABLE 5

| | Example | Example | Example | Example | Example |
|---|---|---|---|---|---|
| Substance | 10 | 11 | 12 | 13 | 14 |
| 1^{st} stage | [phr] | [phr] | [phr] | [phr] | [phr] |
| Buna VSL | 75.0 | 75.0 | 75.0 | 75.0 | 75.0 |
| 4515-0 | | | | | |
| Buna CB 24 | 25.0 | 25.0 | 25.0 | 25.0 | 25.0 |
| Ultrasil | 80.0 | 80.0 | 80.0 | 80.0 | 80.0 |
| 7000 GR | | | | | |
| Si 69 | 7.0 | — | — | — | — |
| Silane | — | 7.0 | — | — | — |
| Example 1 | | | | | |
| Silane | — | — | 7.0 | — | — |
| Example 2 | | | | | |
| Silane | — | — | — | 7.0 | — |
| Example 3 | | | | | |
| Silane | — | — | — | — | 7.0 |
| Example 4 | | | | | |
| ZnO | 2.5 | 2.5 | 2.5 | 2.5 | 2.5 |
| Stearic acid | 1.0 | 1.0 | 1.0 | 1.0 | 1.0 |
| Naftolen ZD | 32.5 | 32.5 | 32.5 | 32.5 | 32.5 |
| Vulkanox | 2.0 | 2.0 | 2.0 | 2.0 | 2.0 |
| 4020 | | | | | |
| Protector | 1.5 | 1.5 | 1.5 | 1.5 | 1.5 |
| G35P | | | | | |
| 3^{rd} stage | | | | | |
| Stage 2 | | | | | |
| batch | | | | | |
| DPG | 2.0 | 2.0 | 2.0 | 2.0 | 2.0 |
| CBS | 1.7 | 1.7 | 1.7 | 1.7 | 1.7 |
| Sulfur | 2.2 | 2.2 | 2.2 | 2.2 | 2.2 |

The silanes are metered in equal weights in Examples 10-14.

The rubber compound is prepared in three stages in an internal mixer in accordance with the data given in Table 2 and vulcanised at 165° C. for 20 min.

The rubber testing takes place in accordance with the test methods given in Table 3.

The following technical data for crude mixture and vulcanisation product are determined (Table 6):

TABLE 6

| | Unit | Example 10 | Example 11 | Example 12 | Example 13 | Example 14 |
|---|---|---|---|---|---|---|
| Crude mixture results | | | | | | |
| Feature: | | | | | | |
| Hitec 165° C. | | | | | | |
| Dmax-Dmin | [dNm] | 6.6 | 6.6 | 6.5 | 6.4 | 6.3 |
| t 10% | [min] | 5.5 | 5.7 | 5.6 | 5.2 | 5.5 |
| t 90% | [min] | 10.8 | 11.9 | 17.8 | 17.5 | 18.4 |
| ML 1 + 4 100° C. 3^{rd} stage | [ME] | 53 | 39 | 39 | 40 | 38 |
| Vulcanisation product results | | | | | | |
| Feature: | | | | | | |
| Tensile test on ring | | | | | | |
| Tensile strength | [MPa] | 14.7 | 13.4 | 14.4 | 14.2 | 13.8 |
| Mdodulus 100% | [MPa] | 1.9 | 1.9 | 2.2 | 2.1 | 2.1 |
| Modulus 300% | [MPa] | 10.1 | 9.6 | 11.1 | 11.2 | 10.2 |
| Elongation at break | [%] | 380 | 370 | 350 | 350 | 370 |
| Modulus 300%/100% | [−] | 5.3 | 5.1 | 5.0 | 5.3 | 4.9 |
| Shore A hardness (23° C.) | [SH] | 64 | 60 | 61 | 61 | 62 |
| Ball rebound 60° C. | [%] | 60.1 | 60.5 | 62.0 | 62.6 | 60.5 |
| DIN abrasion | [mm³] | 62 | 71 | 55 | 57 | 63 |
| Goodrich flexometer. | | | | | | |
| 0.175 inch, 25 min., 23° C. | | | | | | |
| Contact temperature | [° C.] | 48 | 45 | 47 | 45 | 46 |
| Puncture temperature | [° C.] | 95 | 85 | 90 | 87 | 89 |
| Permanent set | [%] | 2.9 | 1.8 | 1.5 | 1.4 | 1.6 |
| MTS, 16 Hz, 50 N +/− 25 N | | | | | | |
| E*, 0° C. | [MPa] | 15.1 | 12.4 | 13.1 | 15.7 | 12.5 |
| E*, 60° C. | [MPa] | 7.5 | 7.5 | 7.9 | 8.4 | 7.6 |
| Loss factor tanδ, 0° C. | [−] | 0.329 | 0.271 | 0.271 | 0.308 | 0.274 |
| Loss factor tanδ, 60° C. | [−] | 0.148 | 0.123 | 0.119 | 0.124 | 0.119 |
| Phillips dispersion | [−] | 8 | 8 | 8 | 8 | 7 |

As shown by Table 6, the silane according to the invention in Example 13 has the shortest t 10% time, the highest 300% modulus and the highest ball rebound 60° C. value when metered in equal weights, which indicates an improved rolling resistance in tire treads. Moreover, the 300%/100% reinforcing factor of Example 13 according to the invention is higher than that of the silanes containing shorter or longer alkyl chains (Examples 11, 12 and 14) and is the same as the Si 69 reference. The loss factor tans 0° C. displays the highest value for Example 13 according to the invention with the variation in alkyl chain length, which indicates an improved wet skidding of the tires.

The disclosures in priority applications DE 101 47 520.9 filed Sep. 26, 2001 and DE 101 63 945.7 filed Dec. 22, 2001, are hereby incorporated by reference.

1. A blocked mercaptosilane having the following general formula I
(R¹O)₃Si—R²—S—C(═O)—C₁₇H₃₅ (I),
wherein
R¹, independently of one another, represents H or (C₁-C₈) alkyl,
R² represents a linear or branched, saturated or unsaturated (C¹-C₈) divalent hydrocarbon,
and C₁₇H₃₅ is branched or linear.

2. The blocked mercaptosilane according to claim 1, wherein R¹, independently of one another, represents methyl or ethyl, R² represents CH₂, CH₂CH₂, CH₂CH₂CH₂, CH₂CH₂CH₂CH₂, CH(CH₃), CH₂CH(CH₃), C(CH₃)₂, CH(C₂H₅), CH₂CH₂CH(CH₃), CH₂CH(CH₃)CH₂ or 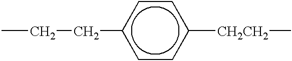
and C₁₇H₃₅ is linear.

3. The blocked mercaptosilane according to claim 1, wherein R¹ is ethyl, R² is CH₂CH₂CH₂, and C₁₇H₃₅ is linear.

4. The blocked mercaptosilane according to claim 1, which is (CH₃O)₃Si—CH₂—S—C(═O)—C₁₇H₃₅, (CH₃O)₃Si—CH₂CH₂—S—C(═O)—C₁₇H₃₅, (CH₃O)₃S₁—CH₂CH₂CH₂—S—C(═O)—C₁₇H₃₅, (CH₃O)₃Si—CH₂CH₂CH₂CH₂—S—C(═O)—C₁₇H₃₅, (CH₃O)₃Si—CH₂CH₂CH₂CH₂CH₂—S—C(═O)—C₁₇H₃₅, (C₂H₅O)₃Si—CH₂—S—C(═O)—C₁₇H₃₅, (C₂H₅O)₃Si—CH₂CH₂—S—C(═O)—C₁₇H₃₅, (C₂H₅O)₃Si—CH₂CH₂CH₂—S—C(═O)—C₁₇H₃₅, (C₂H₅O)₃Si—CH₂CH₂CH₂CH₂—S—C(═O)—C₁₇H₃₅ or (C₂H₅O)₃Si—CH₂CH₂CH₂CH₂CH₂—S—C(═O)—C₁₇H₃₅.

5. A process for the production of the blocked mercaptosilanes of the general formula I
(R¹O)₃Si—R²—S—C(═O)—C₁₇H₃₅ (I),
wherein
R¹, independently of one another, represents H or (C₁-C₈) alkyl,
R² represents a linear or branched, saturated or unsaturated (C₁-C₈) divalent hydrocarbon,
and C₁₇H₃₅ is branched or linear,
comprising reacting a mercaptosilane of the formula (R¹O)₃Si—R²—SH with stearoyl chloride in the presence of an auxiliary base in a suitable organic solvent to form a mixture, heating the mixture to boiling point to complete the reaction, filtering off the blocked mercaptosilane from the solid residue that forms and distilling off the solvent.

6. The process according to claim 5, wherein R¹, independently of one another, represents methyl or ethyl, R² represents CH₂, CH₂CH₂, CH₂CH₂CH₂, CH₂CH₂CH₂CH₂, CH(CH₃), CH₂CH(CH₃), C(CH₃)₂, CH(C₂H₅), CH₂CH₂CH(CH₃), CH₂CH(CH₃)CH₂ or 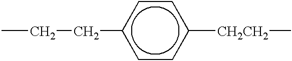
and C₁₇H₃₅ is linear.

7. The process according to claim 5, wherein R¹ is ethyl, R² is CH₂CH₂CH₂, and C₁₇H₃₅ is linear.

8. The process according to claim 5, wherein the blocked mercaptosilane is (CH₃O)₃Si—CH₂—S—C(═O)—C₁₇H₃₅, (CH₃O)₃Si—CH₂CH₂—S—C(═O)—C₁₇H₃₅, (CH₃O)₃Si—CH₂CH₂CH₂—S—C(═O)—C₁₇H₃₅, (CH₃O)₃Si—CH₂CH₂CH₂CH₂—S—C(═O)—C₁₇H₃₅, (CH₃O)₃Si—CH₂CH₂CH₂CH₂CH₂—S—C(═O)—C₁₇H₃₅, (C₂H₅O)₃Si—CH₂—S—C(═O)—C₁₇H₃₅, (C₂H₅O)₃Si—CH₂CH₂—S—C(═O)—C₁₇H₃₅, (C₂H₅O)₃Si—CH₂CH₂CH₂—S—C(═O)—C₁₇H₃₅, (C₂H₅O)₃Si—CH₂CH₂CH₂CH₂—S—C(═O)—C₁₇H₃₅ or (C₂H₅O)₃Si—CH₂CH₂CH₂CH₂CH₂—S—C(═O)—C₁₇H₃₅.

9. A composition containing rubber, filler and optionally other rubber auxiliaries, and also at least one blocked mercaptosilane according to claim 1 in a quantity of 0.1 to 15 wt. %, based on the quantity of said filler, and optionally a deblocking agent.

10. The composition according to claim 9, wherein R¹, independently of one another, represents methyl or ethyl, R² represents CH₂,CH₂CH₂, CH₂CH₂CH₂, CH₂CH₂CH₂CH₂, CH(CH₃), CH₂CH(CH₃), C(CH₃)₂, CH(C₂H₅), CH₂CH₂CH(CH₃), CH₂CH(CH₃)CH₂ or 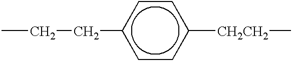
and C₁₇H₃₅ is linear.

11. The composition according to claim 9, wherein R¹ is ethyl, R² is CH₂CH₂CH₂, and C₁₇H₃₅ is linear.

12. The composition according to claim 9, wherein the blocked mercaptosilane is (CH₃O)₃Si—CH₂—S—C(═O)—C₁₇H₃₅, (CH₃O)₃Si—CH₂CH₂—S—C(═O)—C₁₇H₃₅, (CH₃O)₃Si—CH₂CH₂CH₂—S—C(═O)—C₁₇H₃₅, (CH₃O)₃Si—CH₂CH₂CH₂CH₂—S—C(═O)—C₁₇H₃₅, (CH₃O)₃Si—CH₂CH₂CH₂CH₂CH₂—S—C(═O)—C₁₇H₃₅, (C₂H₅O)₃Si—CH₂—S—C(═O)—C₁₇H₃₅, (C₂H₅O)₃Si—CH₂CH₂—S—C(═O)—C₁₇H₃₅, (C₂H₅O)₃Si—CH₂CH₂CH₂—S—C(═O)—C₁₇H₃₅, (C₂H₅O)₃Si—CH₂CH₂CH₂CH₂—S—C(═O)—C₁₇H₃₅ or (C₂H₅O)₃Si—CH₂CH₂CH₂CH₂CH₂—S—C(═O)—C₁₇H₃₅.

13. The composition according to claim 9, wherein the rubber is at least one rubber selected from the group consisting of BR, IR, SBR, IIR, NBR, HNBR, and EPDM.

14. The composition according to claim 9, wherein the filler is at least one filler selected from the group consisting of carbon blacks, carbon blacks containing heteroatoms, silicas, mixed oxides comprising a silica and a metal oxide, synthetic silicates, synthetic and natural aluminium oxides and hydroxides, natural silicates, glass fibres, glass fibre products, and microglass beads.

15. The composition according to claim 9, wherein the filler comprises a carbon black with BET surface areas of 20 to 400 m²/g or a highly disperse silica, produced by precipitation from solutions of silicates, with BET surface areas of 20 to 400 m²/g, said filler being present in quantities of 5 to 150 parts by weight, based on 100 parts of the rubber.

16. The composition according to claim 9, comprising 0.1 to 15 parts by weight of a compound of formula (I), based on 100 parts by weight of the filler.

17. The composition according to claim 16, comprising 5 to 10 parts by weight of a compound of formula (I), based on 100 parts by weight of the filler.

18. A process for producing the composition according to claim 9, comprising mixing the rubber, the filler, the blocked mercaptosilane and the optional other rubber auxiliaries, and the optional deblocking agent, in a mixing unit.

19. A product comprising the blocked mercaptosilanes according to claim 1, wherein the product is selected from the group consisting of a pneumatic tire, tire tread, cable sheath, hose, transmission belt, conveyor belt, roller coating, tire, shoe sole, packing ring and damping element.
